(19) United States
(12) Patent Application Publication
(10) Pub. No.: US 2010/0235048 A1
(43) Pub. Date: Sep. 16, 2010

(54) PROCESS AND DEVICE FOR DETERMINING A STEERING WHEEL ANGLE

(76) Inventors: Martina Richerzhagen, Ostercappeln (DE); Felix Haeusler, Osnabruck (DE); Michael Klank, Osnabruck (DE); Jens Steinkamp, Alfhausen (DE)

Correspondence Address: MCGLEW & TUTTLE, PC, P.O. BOX 9227, SCARBOROUGH STATION, SCARBOROUGH, NY, 10510-9227, US

(21) Appl. No.: 12/305,677

(22) PCT Filed: Jun. 12, 2007
(86) PCT No.: PCT/DE2007/001040

§ 371 Date: Feb. 19, 2009

(30) Foreign Application Priority Data
Jun. 22, 2006 (DE) 10 2006 029 109.3

(51) Int. Cl. G06F 19/00

(52) U.S. Cl. 701/41

(57) ABSTRACT

A process is provided for determining a steering wheel angle (δ_{LRW}) of a steering wheel (58), which is mounted rotatably on a vehicle body (6) and by which a wheel (14) is pivotable or is pivoted in relation to the vehicle body (6), and which wheel is connected to the vehicle body (6) via the intermediary of a joint (8). The joint is provided with an angle measuring device, which detects a deflection (ω) of the joint (8), which deflection depends on the steering wheel angle (δ_{LRW}). An angle of rotation (δ_{STS}) of the steering wheel (58) relative to the vehicle body (6) is determined by a steering angle sensor (61). A plurality of sectors (S) per steering direction are assigned to the range of the steering wheel angles (δ_{LRW}) that can be assumed by the steering wheel (58). One of the sectors (S) is determined on the basis of the deflection (ω), and the steering wheel angle (δ_{LRW}) is determined on the basis of the angle of rotation (δ_{STS}) and the sector (S) determined.

### CROSS REFERENCE TO RELATED APPLICATIONS

This application is a United States National Phase application of International Application PCT/DE 2007/001040 and claims the benefit of priority under 35 U.S.C. §119 of German Patent Application DE 10 2006 029 109.3 filed Jun. 22, 2006, the entire contents of which are incorporated herein by reference.

### FIELD OF THE INVENTION

The present invention pertains to a process for determining a steering wheel angle of a steering wheel, which is mounted rotatably on a vehicle body and by means of which a wheel is pivotable or pivoted in relation to the vehicle body, which wheel is connected to the vehicle body via the intermediary of a joint, which joint has an angle measuring device, which detects a deflection of the joint, which deflection depends on the steering wheel angle, wherein an angle of rotation of the steering wheel in relation to the vehicle body is determined by means of a steering angle sensor. Furthermore, the present invention pertains to a device for determining a steering wheel angle.

### BACKGROUND OF THE INVENTION

A steering angle sensor with a combination of a mechanical counting means and an optical code disk, which is scanned within one revolution of the steering wheel, is described in DE 101 10 785 C2 for determining the absolute angle of rotation. A counting unit for counting the full revolutions of the steering wheel in the form of an intermittent motion is known from DE 196 01 965 A1. It is proposed in DE 100 57 674 A1 that the path of displacement of a toothed rack of a steering gear, caused by the turning angle of the steering wheel, be detected to determine the absolute steering angle.

Multiturn steering angle sensors can be used to unambiguously determine the instantaneous steering angle of a motion of the steering wheel by up to three full revolutions. The use of such a sensor system is associated with very high costs. More cost-effective single-turn steering angle sensors, which can unambiguously image only one full revolution or less, are used as an alternative in connection with additional vehicle dynamic variables, e.g., wheel rpms of the individual wheels, to detect the steering wheel angle. This process has the drawback that a certain path traveled or speed of travel is necessary to make possible an unambiguous determination of the steering angle.

DE 10 2004 053 690 A1 discloses a sensor device for determining a steering angle during motion of the steering wheel in a vehicle with a steering angle sensor, wherein an additional measurement of elastokinematic angles is performed on at least one joint, which is correlated with the position of a steerable wheel and which comprises an integrated sensor system for magnetoresistive angle detection, to transmit or determine the absolute steering angle. The joint has a ball pivot with a pin, in which a magnetic field transducer is arranged, which is in magnetic functional connection with a magnetic field detector. Angular motions about the longitudinal axis of the pin can thus be detected. The steering angle sensor makes available an ambiguous, periodical signal over the entire possible steering angle range, so that the angle sensor system, which yields unambiguous angle information, is used to determine the steering angle. The ambiguous ranges of the steering angle are linked by a logic unit or computing unit with an unambiguous range of the signal of the angle sensor such that determination of the steering angle is possible.

A steering wheel can usually be turned in two mutually opposite directions, so that the steering angle sensor may yield the same signal for an angle of rotation of, e.g., 30° during turning to the left as for an angle of rotation of 330° during turning to the right. Furthermore, the steering angle sensor may yield the same signal for an angle of rotation of 390° as during turning to the left. This ambiguity of the steering angle sensor signals may lead to problems and especially confusions in the analysis of the detected angles.

### SUMMARY OF THE INVENTION

The object of the present invention is to reduce or avoid the possibility of occurrence of such problems.

A plurality of sectors per steering direction are assigned to the range of the steering wheel angle in the process according to the present invention for determining a steering wheel angle of a steering wheel, which is mounted rotatably on a vehicle body and by means of which a wheel is pivotable or pivoted in relation to the vehicle body, wherein said wheel is connected to the vehicle body via the intermediary of a joint, which has an angle measuring device, which detects a deflection of the joint, which deflection depends on the steering wheel angle, wherein an angle of rotation of the steering wheel relative to the vehicle body is determined by means of a steering angle sensor. The steering wheel angle can be determined now on the basis of the angle of rotation and deflection. One of the sectors is preferably determined on the basis of the deflection and the steering wheel angle is determined on the basis of the angle of rotation and the sector determined. The vehicle body is preferably part of a vehicle or motor vehicle. Furthermore, the steering wheel is rotatable especially in two mutually opposite steering directions or orientations (steering directions).

Due to the fact that a plurality of sectors per steering direction are assigned to the range of the steering wheel angles that the steering wheel can assume, it is possible to distinguish different steering wheel angles at angles of rotation over the particular section. Confusions can thus be avoided in the analysis of the detected angles.

The term “steering wheel angle” shall be defined here as an angle through which the steering wheel has been or is turned in relation to the vehicle body. This angle may exceed 360° depending on the direction of turning.

The term “angle of rotation” shall be defined here as the angle detected by the steering angle sensor, independently from whether, e.g., a single-turn steering angle sensor or a multiturn steering angle sensor is used.

The size of each sector is preferably smaller than or equal to half the angle range that can be detected by the steering angle sensor. In particular, the size of the sector corresponds to half the value of the difference between the maximum detectable angle of rotation and the minimum detectable angle of rotation. The size of the sector is, e.g., 180° in case of single-turn steering angle sensors that can cover or detect an angle of up to 360° (one revolution). The sector sizes may be, in principle, different. However, all sectors preferably have the same size to simplify the calculation.

The total number of sectors is obtained from the sum of the sectors for each steering direction. For example, a maximum angle or a maximum possible steering wheel angle, which corresponds to the value of the steering wheel angle having the largest possible value, may be used to determine this number. The number of sectors per steering direction will then be obtained, e.g., from the maximum angle divided by the size of the sector. Since this quotient may also be a non-integer, the number of sectors is preferably rounded up. This may be done, e.g., by first rounding off the number of sectors, after which the value of one is added to the number of sectors. The integral function, which is also called the Gaussian bracket and is designed, e.g., by the short name “floor” (floor function in English), may be used for rounding off. By contrast, the rounding-up function, which is also designated by an abbreviation as “ceil” (ceiling function in English), may be used for rounding up.

The number of sectors may differ for each steering direction. However, the same number of sectors is preferably assigned to both steering directions to simplify the calculations.

The angle of rotation may not possibly yield an unambiguous signal when a single-turn steering angle sensor is used. In particular, the steering angle sensor provides an unambiguous, periodical signal over the entire possible steering angle range. The deflection detected by the angle measuring device is therefore used to determine the sector in which the steering wheel angle is located. An alternative steering wheel angle may be determined on the basis of the deflection and the sector in which the alternative steering wheel angle is located can be determined.

The value of the angle of rotation is usually relatively accurate, whereas the alternative steering wheel angle may be relatively inaccurate. It is thus possible that an incorrect sector has been determined. A checking is therefore preferably performed to determine whether the angle of rotation can be located in the determined sector. If the angle of rotation can be located in the sector determined, this remains unchanged. If, by contrast, the angle of rotation and the sector determined are incompatible with one another, this sector must be corrected or another sector must be determined, in which the angle of rotation is located. Various methods are possible for this correction. However, the other sector is determined, in particular, depending on the sector limit to which the angle of rotation is closest. It may be, e.g., the sector or another sector from the sector limit of which the angle of rotation has the smallest (angular) distance. This can be checked, e.g., by comparing the angle of rotation to half the sector size. If the angle of rotation is negative, this comparison can also be carried out with the negative value of half the sector size.

The steering wheel angle can now be determined. A correction factor, with which the number of sectors that have been passed through during the steering motion can be determined, is preferably used to calculate the steering wheel angle. The steering wheel angle can then be calculated on the basis of the angle of rotation, the size of the sectors and the correction factor, which is determined, e.g., from the number of sectors passed through. The steering wheel angle is preferably obtained from the sum of the angle of rotation and the product of the correction factor by a multiple of the sector size, which multiple corresponds especially to twice the sector size.

According to DE 10 2004 053 690 A1, only an angular motion about the longitudinal axis of the ball pivot 3 is detected. However, inward deflections also regularly occur in the suspension of a steerable wheel, besides the steering motions, so that a motion based on an inward deflection motion may be superimposed to an angular motion based on a steering operation. Since the ball pivot can now also perform a pivoting motion and not only a rotary motion, the measurement results of the sensor system may be inaccurate or distorted.

The deflection of the joint is determined therefore by the angle measuring device as angles or angle signals in at least two different directions in space. By taking into account or detecting the deflection of the joint as at least two angles, which are directed in different directions in space, more information is available on the state of the joint than in the solution according to DE 10 2004 053 690 A1. The impairment in the accuracy of measurement can thus be avoided or at least reduced. In particular, the fact that the wheel is preferably spring-mounted on the vehicle body and can perform inward and outward deflections in relation to the vehicle body is taken into account hereby. For example, the distance between the center of the wheel and the vehicle body in the direction of the vertical axis of the vehicle or in the vertical direction is called the inward deflection here. The directions in space are preferably located on different and non-parallel planes (detection planes), so that the angles can form components of the deflection.

The deflection is available especially in the form of at least two electrical signals, which carry or represent the angles of the deflection as information. These electrical signals are preferably sent by the angle measuring device.

The angle of rotation is available, in particular, in the form of at least one electrical signal, which carries or represents the angle of rotation as information. This electrical signal is preferably sent by the steering angle sensor.

The process according to the present invention is especially suitable for a so-called single-turn steering angle sensor, which, though being able to perform multiple revolutions, can resolve or detect a maximum angle range of 360° only. It is thus possible that the angles of rotation that can be determined by the steering angle sensor are smaller than or equal to a maximum angle of rotation and greater than or equal to a minimum angle of rotation, wherein the value of the difference between the maximum angle of rotation and the minimum angle of rotation is smaller than or equal to 360°. In particular, the steering wheel angles that can be assumed by the steering wheel are smaller than or equal to a maximum steering wheel angle and greater than or equal to a minimum steering wheel angle, wherein the value of the difference between the maximum steering wheel angle and the minimum steering wheel angle is greater than the value of the difference between the maximum angle of rotation and the minimum angle of rotation.

The wheel of the vehicle may be in connection with the vehicle body via a wheel suspension, and the joint is preferably part of this wheel suspension. The joint is arranged here in the wheel suspension especially such that a pivoting of the wheel also leads to a change of the deflection and the angles and/or vice versa. The joint may be arranged at the wheel, because this wheel can be pivoted by means of the steering wheel. Furthermore, the wheel has, in particular, a wheel carrier, which is connected to the vehicle body, e.g., via at least one control arm and/or a track rod. However, the joint may also be connected to the control arm or to the track rod. The joint is connected especially to the wheel carrier or is articulated to same. Furthermore, the wheel or wheel carrier may be connected to the control arm or track rod via the joint.

The steering wheel angle can be determined, in principle, by means of the deflection obtained from the angle measuring device. However, a steering wheel angle determined in this manner is frequently too inaccurate or is subject to an excessively great error. The angle of rotation sent by the steering angle sensor is therefore additionally used for the more accurate determination of the steering wheel angle. To make it possible to make a distinction between the more accurate steering wheel angle and the more inaccurate steering wheel angle, the steering wheel angle determined from the deflection is called an alternative steering wheel angle. The steering wheel angle determined additionally by taking into account the angle of rotation is called the steering wheel angle or the absolute steering wheel angle.

The alternative steering wheel angle can be determined in different ways. It is possible, for example, to determine the alternative steering wheel angle by using a neuronal network, to which the deflection or angles are sent as input variables. It is possible, in addition or as an alternative, to determine the alternative steering wheel angle by the use of a performance characteristic, which assigns the corresponding alternative steering wheel angle to the angles detected by the angle measuring device. Such a performance characteristic can be determined, e.g., by an inward deflection of the wheel and/or a steering wheel angle being set in a first step. The inward deflection and the steering wheel angle lead to a wheel position that is detected by means of the angle measuring device, so that the angles of the joint that belong to the inward deflection and to the steering wheel angle are determined in a second step. The angles, the steering wheel angle and optionally the inward deflection now form a measuring point, which is entered in the performance characteristic. The inward deflection and/or the steering wheel angle can now be varied in a third step and, e.g., the second step can be repeated or it is possible to go back to the second step. The second and third steps can be repeated until a sufficient number of measurement points are obtained.

The present invention pertains, furthermore, to a device for determining a steering wheel angle, with a steering wheel, which is mounted rotatably on a vehicle body and by means of which a wheel can be pivoted relative to the vehicle body, which said wheel is connected to the vehicle body via the intermediary of a joint, which has an angle measuring device, by means of which a deflection of the joint, which depends on the steering wheel angle, can be detected, and an angle of rotation of the steering wheel relative to the vehicle body can be detected by means of a steering angle sensor, and wherein the steering wheel angle can be determined on the basis of the angle of rotation and the deflection by means of an analysis means. The deflection of the joint can be detected here by the angle measuring device as an angle in at least two different directions in space.

Due to the fact that the angle measuring device can detect the deflection of the joint as at least two angles, which are directed in different directions in space, the same advantages can be obtained as those that were already described above with reference to the process according to the present invention, which is or can preferably be carried out by means of or with the use of the device according to the present invention. The analysis means is connected, in particular, to the steering angle sensor and to the angle measuring device and may be formed, e.g., by a digital computer. Furthermore, the device may be a vehicle or a part of a vehicle. The vehicle is preferably a motor vehicle.

The angle measuring device has, in particular, a sensor assembly unit, which preferably comprises two sensors, wherein the sensors are assigned to the different directions in space and are especially also aligned in the different directions in space. The sensors are preferably aligned vertically in relation to one another.

The angle measuring device is especially a magnetic measuring device and preferably has a magnet movable in relation to the sensors, wherein the sensors are designed as magnetic field-sensitive sensors and interact especially with the magnetic field of the magnet. The magnet may be designed as a permanent magnet or as an electromagnet. The magnetic field-sensitive sensors may be, e.g., magnetoresistive sensors or Hall effect sensors.

The joint is preferably a ball and socket joint and has a housing and a ball pivot, which is mounted in same and which is especially rotatable and pivotable in relation to the housing. The magnet may be arranged at or in the ball pivot, whereas the sensor assembly unit is seated at or in the housing. However, a reversed arrangement is also possible, in which the sensor assembly unit is arranged at or in the ball pivot and the magnet is seated at or in the housing.

The magnetization of the magnet is preferably directed obliquely to a steering axis, about which the wheel or a wheel carrier associated with same pivots relative to the vehicle body during a steering or rotary motion of the steering wheel. The angle measuring device yields especially clear signals in such an arrangement. The wheel is mounted especially rotatably at the wheel carrier, which is connected to the vehicle body movably and especially pivotably via at least one control arm and/or a track rod. If the magnet is attached to the ball pivot, this may be attached to the wheel carrier, e.g., with its longitudinal axis aligned obliquely in relation to the steering axis, whereas the housing can be attached to the control arm or to the track rod. However, a reversed arrangement is also possible. Furthermore, the control arm or the track rod may be connected to the vehicle body via an additional joint or elastomer bearing. The term “oblique” is defined here especially as an angle that is smaller than 90° and greater than 0°.

The present invention will be described below on the basis of preferred embodiments with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a wheel suspension of a vehicle;

FIG. 2 is an upper suspension arm with a schematic view of a ball and socket joint with integrated angle measuring device;

FIG. 3 is a schematic sectional view through the ball and socket joint;

FIG. 4 is a schematic view of a sensor assembly unit;

FIG. 5 is a schematic top view of the vehicle;

FIG. 6 is the graphic plotting of a steering wheel angle over a spring excursion;

FIG. 7 is the graphic plotting of a horizontal angle over a vertical angle;

FIG. 8 is a performance characteristic for determining an alternative steering wheel angle;

FIG. 9 is the schematic view of a neuronal network for determining an alternative steering wheel angle;

FIG. 10 is a flow chart for a process for determining a steering wheel angle;

FIG. 11 is flow charts for initialization;

FIG. 12 is an example for initialization of the sector;

FIG. 13 is a flow chart for sector recognition;

FIG. 14 is an example for plausibilization of the sector recognition;

FIG. 15 is a flow chart for plausibilization;

FIG. 16 is a flow chart for determining a correction factor;

FIG. 17 is a flow chart for calculating the steering wheel angle;

FIG. 18 is a flow chart for calculating a correction factor according to a second embodiment of the present invention; and

FIG. 19 is a flow chart for determining the sector according to the second embodiment of the present invention.

### DESCRIPTION OF THE PREFERRED EMBODIMENTS

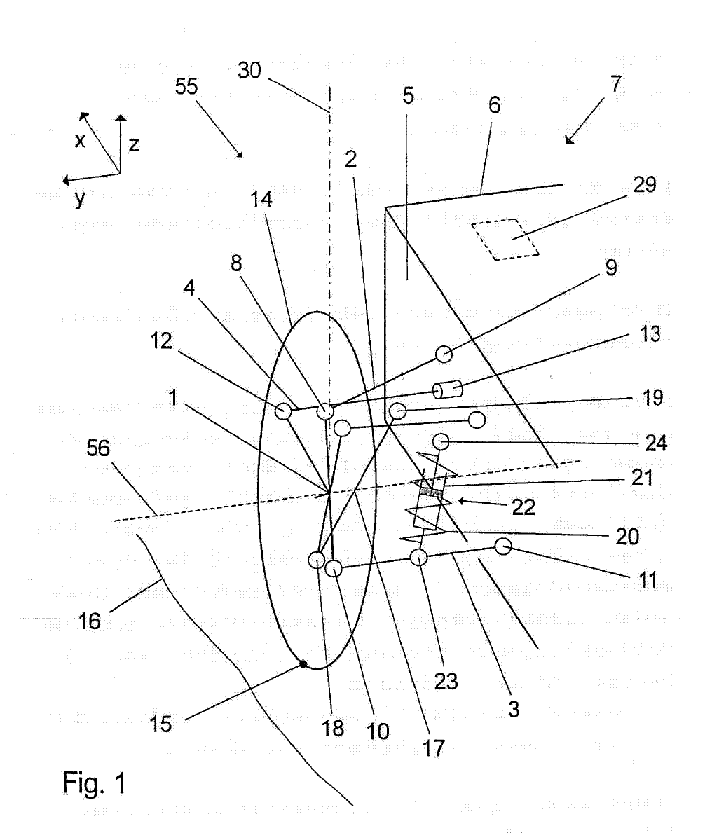

Referring to the drawings in particular, FIG. 1 shows a schematic view of a wheel suspension 55, wherein a wheel carrier 1 is connected via an upper suspension arm 2, a lower suspension arm 3 and a track rod 4 to a carrier element 5, which is part of a vehicle body 6 of a partially shown vehicle 7. The upper suspension arm 2 is connected to the wheel carrier 1 via a ball and socket joint 8 and to the carrier element 5 via an elastomer bearing 9. The lower suspension arm 3 is connected to the wheel carrier 1 via a ball and socket joint 10 and to the carrier element 5 via an elastomer bearing 11. Furthermore, track rod 4 is connected to the wheel carrier 1 via a ball and socket joint 12 and to the carrier element 5 via a steering gear 13 shown schematically, wherein the track rod 4 is displaceable in its longitudinal direction by means of the steering gear 13. Such a displacement of the track rod 4 brings about pivoting of the wheel carrier 1 about a steering axis 30.

A tire or a wheel 14, which is in contact with a road surface 16 shown schematically in a wheel contact point 15, is mounted rotatably on the wheel carrier 1. Furthermore, wheel carrier 1 is connected to the carrier element 5 via a guide control arm 17, which is articulated or connected to the wheel carrier 1 via a ball and socket joint 18 and to the carrier element 5 via an elastomer bearing 19. Wheel suspension 55 is part of a steerable front axle shown schematically, which is designed as a four-arm suspension front axle here.

The lower suspension arm 3 is additionally connected to the carrier element 5 via a spring 20 and a shock absorber 21, wherein spring 20 and shock absorber 21 together form a spring type shock absorber unit 22, which is attached to the lower suspension arm 3 via a joint 23 and to the carrier element 5 via a joint 24. Furthermore, the directions x, y and z in space are indicated in a system of coordinates.

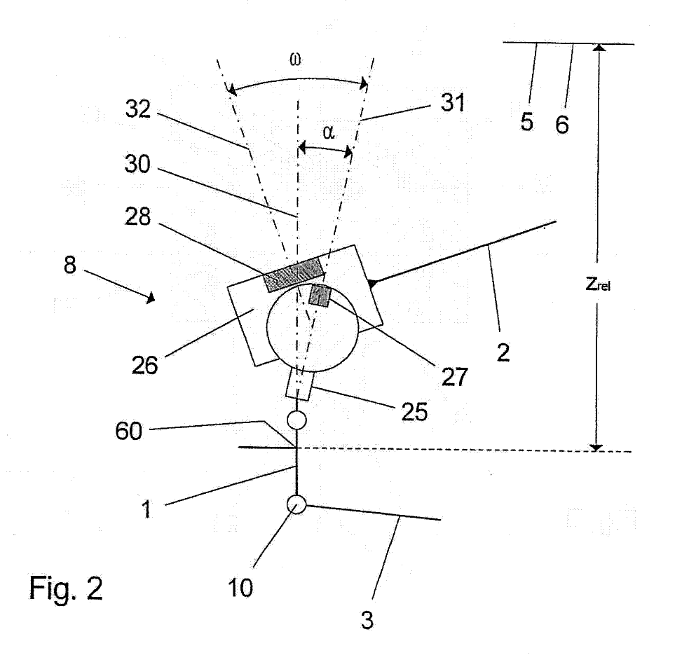

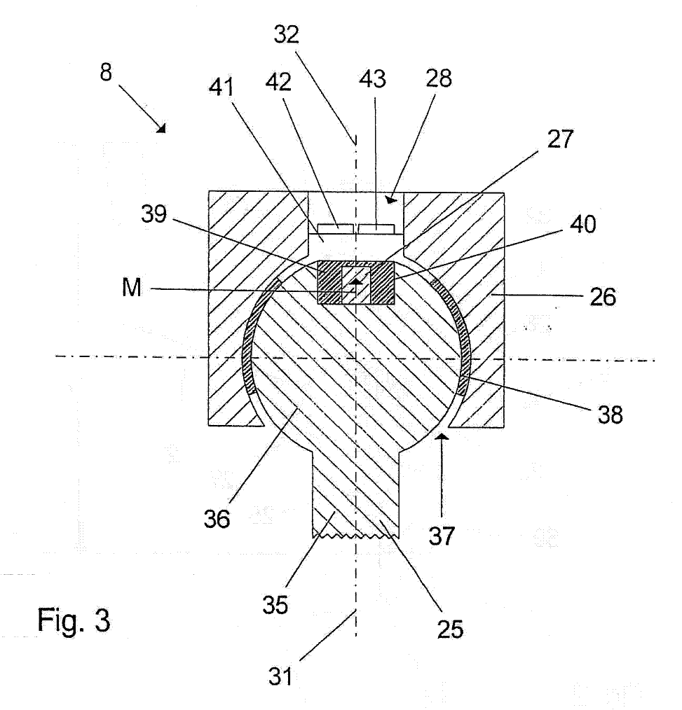

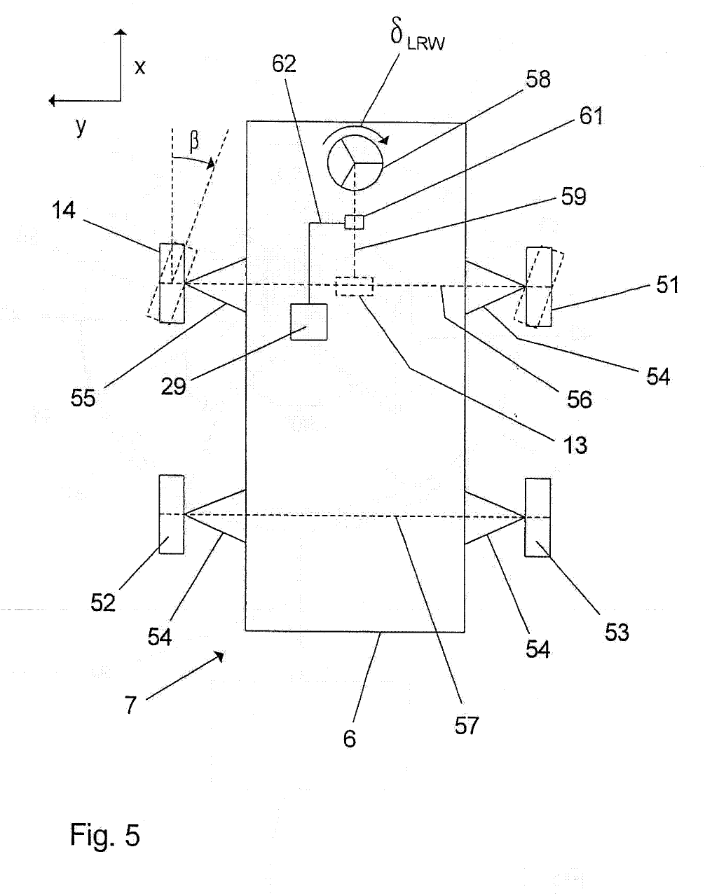

FIG. 2 shows a schematic view of ball and socket joint 8, which has a ball pivot 25 and a ball and socket joint housing 26, in which the ball pivot 25 is mounted rotatably and pivotably. A permanent magnet 27 is arranged in the ball and socket joint housing 26, whereas a magnetic field-sensitive sensor assembly unit 28 is provided in the ball and socket joint housing 26. The magnet 27 and the magnetic field-sensitive sensor assembly unit 28 together form an angle measuring device, which is integrated within the ball and socket joint 8. The ball and socket joint housing 26 is rigidly connected to the upper suspension arm 2, and ball pivot 25 is rigidly connected to the wheel carrier 1, wherein the longitudinal axis 31 of the ball pivot 25 forms angle α with the steering axis 30, and this angle α may be greater than or equal to 0°. The deflection or pivoting ω between the longitudinal axis 31 of the ball pivot 25 and the longitudinal axis 32 of housing 26 can be detected by means of the angle measuring device in the form of two angles, which are located in two different and mutually intersecting planes 33, 34 (see FIG. 5). The direction of magnetization M (see FIG. 3) of magnet 27 coincides here with the longitudinal axis 31 of ball pivot 25, so that angle α also represents the angle between the direction of magnetization and the steering axis 30.

Furthermore, FIG. 2 shows the inward deflection position zᵣₑₗ of wheel 14 and of the wheel carrier 1 in relation to the vehicle body 6 and the carrier element 5. The inward deflection or inward deflected position zᵣₑₗ designates here the distance between the center 60 of wheel 14 and the vehicle body 6, preferably in direction “z” in space.

FIG. 3 shows a schematic sectional view through the ball and socket joint 8, wherein the ball pivot 25 has a pin 35 as well as a joint ball 36 connected to same and juts out of housing 26 through an opening 37 provided in housing 26. Furthermore, the ball pivot 25 is mounted in housing 26 via the intermediary of a ball shell 38.

Magnet 27 is a permanent magnet, whose magnetization is designated by M, wherein magnet 27 is embedded in a non-magnetic material 39 and is seated in a recess 40 provided in joint ball 36. Furthermore, the sensor assembly unit 28 is arranged in a recess 41 provided in housing 26.

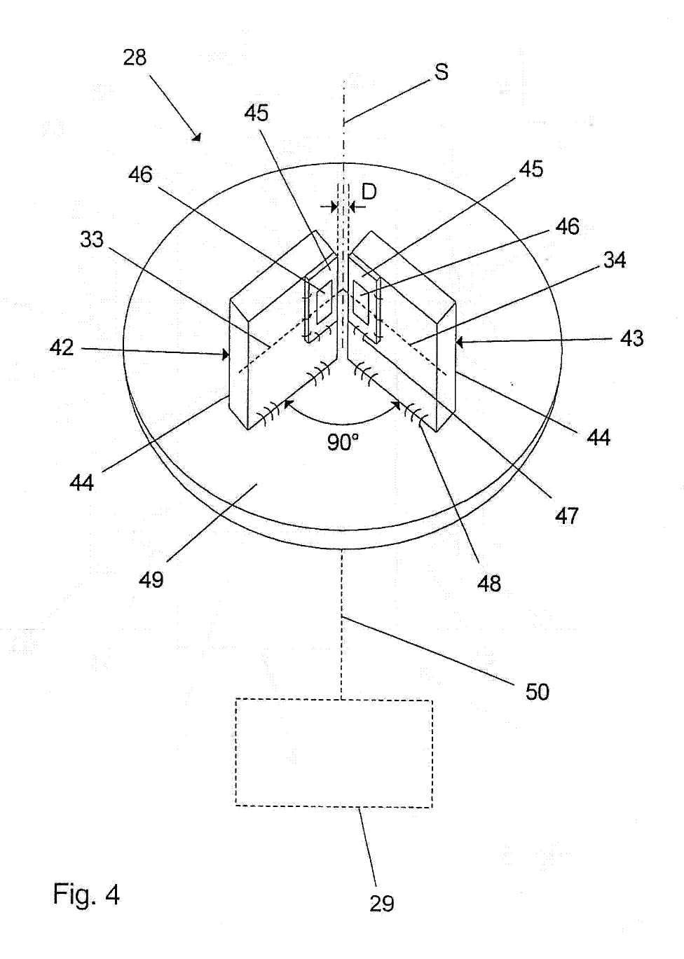

FIG. 4 shows a schematic view of sensor assembly unit 28, wherein two sensors 42 and 43 have a sensor carrier 44 and a sensor element 45 each with a sensitive surface 46. The two sensor carriers 44 and the sensor elements 45 are arranged at a distance D from one another and form an angle of 90° with one another. However, it is also possible to reduce distance D to 0. Furthermore, the sensitive surfaces 46 of the sensor elements 45 form right angles with one another, or, in other words, the two sensitive surfaces 46 are located on planes or detection planes 33 and 34 that form right angles with one another. The section line of the two detection planes 33 and 34 indicated by broken lines, which said section line is designated by S, coincides now with the longitudinal axis 32 of housing 26 or is aligned in parallel to this. It is possible by means of the sensor assembly unit 28 to resolve the pivoting ω between the ball pivot 25 and the housing 26 into two angles directed at right angles to one another and to measure these, so that the location in space of the ball pivot 25 relative to the housing 26 can be determined at high accuracy.

The sensor elements 45 are connected via electrical contacts 47 to the corresponding sensor carrier 44, which is connected via electric contacts 48 to a printed circuit board 49, on which the two sensor carriers 44 are seated. Furthermore, electrical lines 50, which extend up to an analysis means 29, which may likewise be integrated within the sensor assembly unit 28, but is preferably arranged in the vehicle body 6, are connected to printed circuit board 49 (see FIG. 1).

FIG. 5 shows a simplified top view of the motor vehicle 7, which has, in addition to the wheel 14, three more wheels 51, 52 and 53, which are each connected to the vehicle body 6 via wheel suspensions 54 shown schematically. Wheel 14 is connected to the vehicle body 6 via the wheel suspension 55 shown in FIG. 1.

The two wheels 14 and 51 are part of the steerable front axle 56 of the vehicle 7, whereas wheels 52 and 53 are part of a rear axle 57 of the vehicle 7. A steering wheel 58 mounted rotatably on the vehicle body 6 is coupled with the steering gear 13 via the intermediary of a steering axle 59 shown schematically, so that pivoting of the wheels 14 and 51 by an angle β can be or is achieved by rotating the steering wheel 58 by a steering wheel angle δ_{LRW}. Furthermore, a steering angle sensor 61 is coupled with the steering axle 59 and connected to the analysis means 29 via electric lines 62. The steering angle sensor 61 can detect a turning of the steering wheel 58 in relation to the vehicle body 6 as an angle of rotation δ_{STS}. Since the steering angle sensor 61 is preferably designed as a single-turn steering angle sensor, in particular, only up to a maximum of one revolution can be detected or resolved by this. Furthermore, angle β and/or an alternative steering wheel angle δ_{WISEL} can be determined on the basis of the two angles measured by the angle measuring device or the sensor assembly unit 28. The alternative steering wheel angle δ_{WISEL} theoretically corresponds to the steering wheel angle δ_{LRW}, but is practically too inaccurate, so that, in particular, the process described below is used to determine the steering wheel angle δ_{LRW} more accurately.

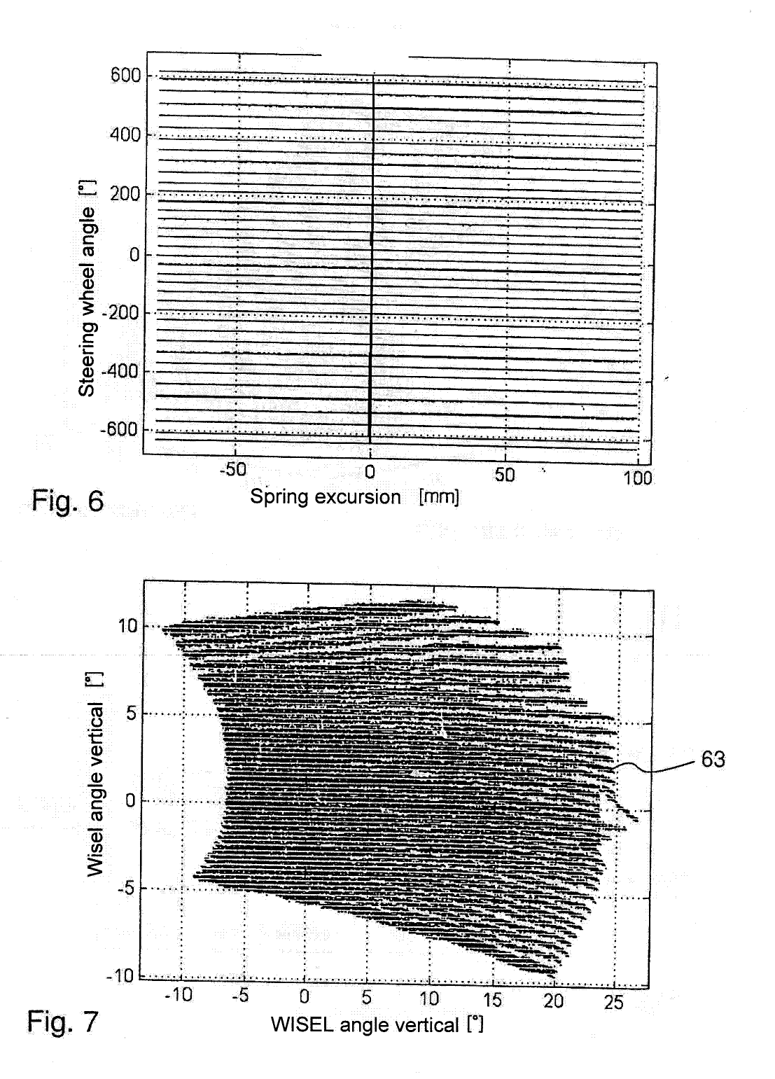

The vehicle 7 is at first measured to determine a performance characteristic, while the front axle 56 is deflected inwardly and outwardly at different steering wheel angles δ_{LRW}. FIG. 6 shows a system of coordinates, in which the steering wheel angle δ_{LRW} of the steering wheel 58 is plotted over the spring excursion or inward deflection zᵣₑₗ of wheel 14. Furthermore, the two angles of the deflection are measured by means of the angle measuring device, and sensor 42 yields, e.g., an angle designated as “WISEL angle horizontal” and sensor 43 yields, e.g., an angle designated as “WISEL angle vertical.” FIG. 7 shows a system of coordinates, in which the measured horizontal angles are plotted over the measured vertical angles, reference number 63 designating the measured curve or the measured points.

The performance characteristic can now be determined, and the alternative steering wheel angle δ_{WISEL} can be determined on the basis of this from the angle data “WISEL angle horizontal” and “WISEL angle vertical.” A rectangular performance characteristic that is mutually perpendicular above the horizontal angle and the vertical angle of the angle measuring device is preferably required for this. However, as can be determined from the measured curve 63 from FIG. 7, the data recorded do not meet this requirement.

Various functions can be used to calculate the performance characteristic corresponding to the above-mentioned requirements, but they are not described in detail. Only the procedure and the methods used are presented.

A mutually perpendicular grid is prepared from the data in a first step. The second step comprises the interpolation around a boundary value beyond the determined boundary of the performance characteristic. The boundary of the performance characteristic is determined for this at first. The corner points of the outer surface elements are determined beginning with a starting point. Three points of the surface elements are determined for this. The Hesse normal form of a surface can be determined from these three points, and this normal form can then be used in turn to calculate every desired point on this surface. Two points are obtained already from the two corner points of the surface element, which are located at the boundary of the performance characteristic. Either the corner point of an adjacent surface element or a measured value outside the boundary of the performance characteristic is selected as the third point. Should it not be possible to determine a third point, the inner surface is used to determine the new interpolation points. The grid produced so far has no rectangular contour, which is understandable in view to FIG. 7. It is therefore desirable to describe the remaining surface elements up to the boundaries of the performance characteristic. This is carried out in a comparable manner as the interpolation of the boundary points.

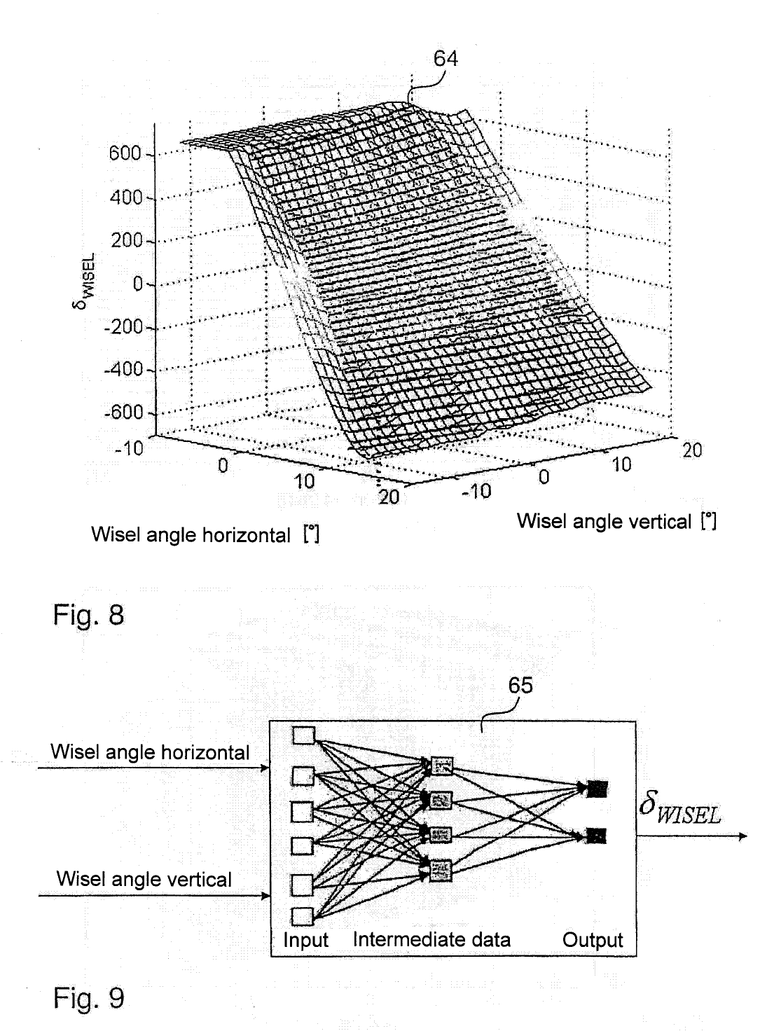

The results can be found in FIG. 8. The performance characteristic 64 determined by means of the angle measuring device of joint 8 as well as the measured points recorded are shown. To avoid extremely high or low values, the resulting performance characteristics are limited to the maximum and minimum possible values of the steering wheel angle.

The grid density is selected to be so high that a required accuracy can be attained. However, it should at the same time also be only so great that the performance characteristic can be entered in a microcontroller. The error analysis of the performance characteristic can be performed as a function of the grid density for selecting the grid density. The error frequency can be plotted for this over the steering wheel angle and the spring excursion.

As is apparent from FIG. 9, a neuronal network 65 can also be used according to one variant instead of a performance characteristic to determine the alternative steering wheel angle. The input variables entered in the network 65 are, as for the performance characteristic 64, the angles “WISEL angle horizontal” and “WISEL angle vertical” determined in the joint 8. The output variable is the alternative steering wheel angle δ_{WISEL}. The same measured data can be used for training the network as for the determination of the performance characteristic.

If both the alternative steering wheel angle δ_{WISEL} and the angle of rotation δ_{STS} are available, a process for sector recognition can be performed. The purpose of this process is to determine the (absolute) steering wheel angle δ_{LRW} from the measurement of the angle of rotation δ_{STS} with the single-turn steering angle sensor 61 and the measurement of the angles of deflection ω by means of the angle measuring device. The information on the absolute steering wheel angle δ_{LRW} shall not possibly depend on the road section already traveled or a velocity, but it should be available immediately after actuation of the ignition. The process used for this consequently operates especially without recursion, i.e., it takes into account only the measured values available at the current point in time.

The term “absolute steering wheel angle” is used to make clear a distinction from the “alternative steering wheel angle.” Both the absolute steering wheel angle δ_{ILRW} and the alternative steering wheel angle δ_{WISEL} are steering wheel angles. However, the alternative steering wheel angle δ_{WISEL} is determined on the basis of the deflection ω or angle (“WISEL angle horizontal” and “WISEL angle vertical”) provided by the angle measuring device, without information from the steering angle sensor 61 being taken into account. The alternative steering wheel angle δ_{WISEL} may thus be inaccurate. The absolute steering wheel angle δ_{LRW} is determined, by contrast, on the basis of the angle of rotation δ_{STS} sent by the steering angle sensor 61 and the alternative steering wheel angle δ_{WISEL} or the deflection ω or angle (“WISEL angle horizontal” and “WISEL angle vertical”) sent by the angle measuring device and is more accurate. The term “absolute” shall not be used here, in particular, in a restricted manner in the sense of “value”, so that the absolute steering wheel angle δ_{LRW} may also be smaller than zero.

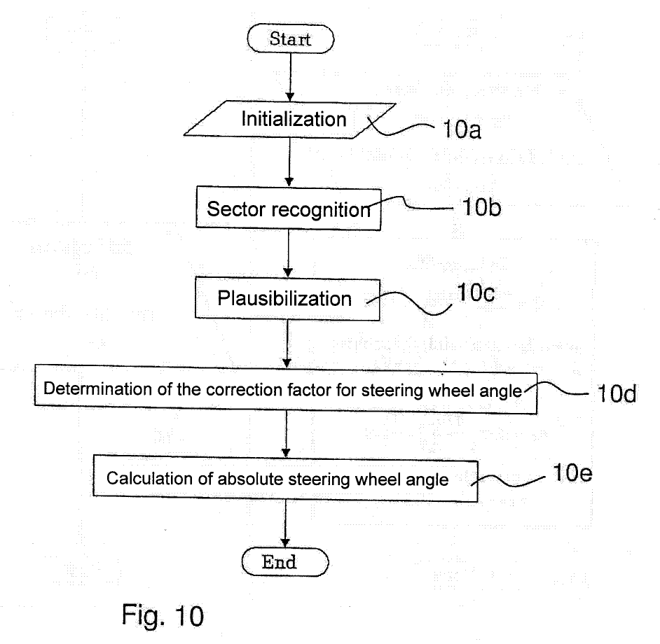

The preferred process for sector recognition and for determining the absolute steering wheel angle δ_{LRW} is divided into different process steps. The sequence of these process steps can be seen in FIG. 10, where an initialization 10a is followed by a sector recognition 10b, which is followed by a plausibilization 10c. A correction factor is then determined in step 10d for the steering wheel angle, after which the absolute steering wheel angle δ_{LRW} is calculated in a step 10e. These process steps will be discussed in more detail below.

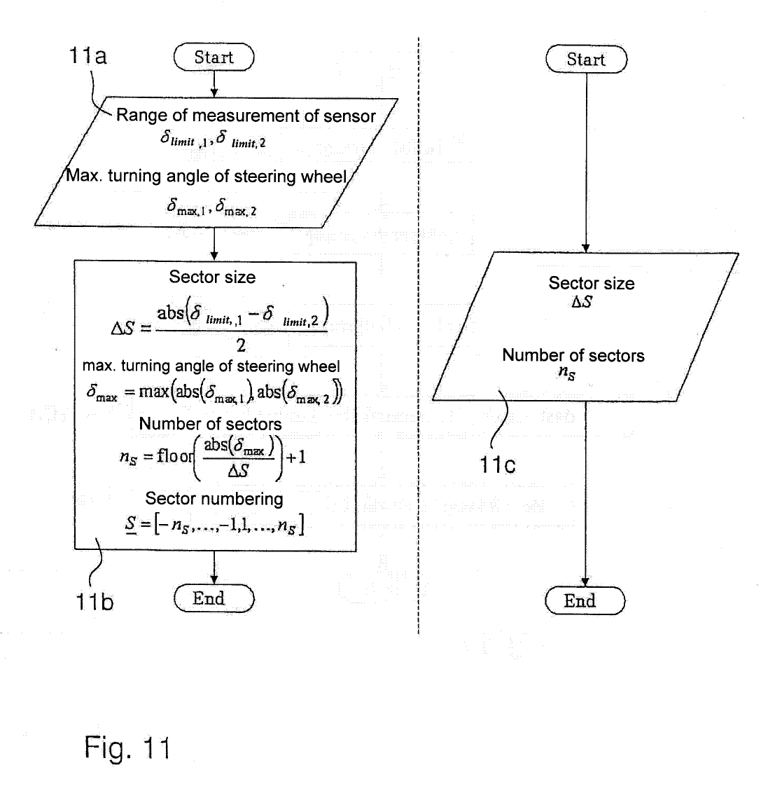

The possible range of measurement of the single-turn steering angle sensor 61, defined by the two limit values δ_{limit,1} and δ_{limit,2}, on the one hand, and, on the other hand, the maximum possible steering wheel angle, defined by the maximum positive and negative steering wheel angle δ_{max,1} and δ_{max,2}, are of interest in the “initialization” shown in FIG. 11. The sector size ΔS is at first calculated from these data according to

$$Δ S = \frac{a bs ( {δ}_{limit , 1} - {δ}_{limit , 2} )}{2}$$

The abbreviation “abs (Argument)” denotes the absolute value function, which yields the absolute value of Argument as a result. The number n_{S} of sectors for one steering direction is obtained from the maximum possible steering wheel angle

$${δ}_{max} = max ( a bs ( {δ}_{max , 1} ) , a bs ( {δ}_{max , 2} ) )$$

$$as$$

$${n}_{S}^{*} = \frac{a b s ( {δ}_{max} )}{Δ S} .$$

The abbreviation “max(Argument 1, Argument 2)” denotes a function that yields as a result the larger of the two arguments Argument 1 and Argument 2.

The value n_{S}* does not always correspond to an integer value, so that the value is at first rounded off and the number one is subsequently added. The result is the number n_{S} of sectors for one steering direction with:

n_{S}=floor(n_{S}*)+1.

The function “floor(Argument)” yields as a result the value of Argument rounded off to an integer. The total number of sectors is now obtained from double the number of sectors for one steering direction.

It is also possible, as an alternative, to set up the program such that the sector size ΔS and the number n_{S} of sectors are preset directly, which appears from step 11c.

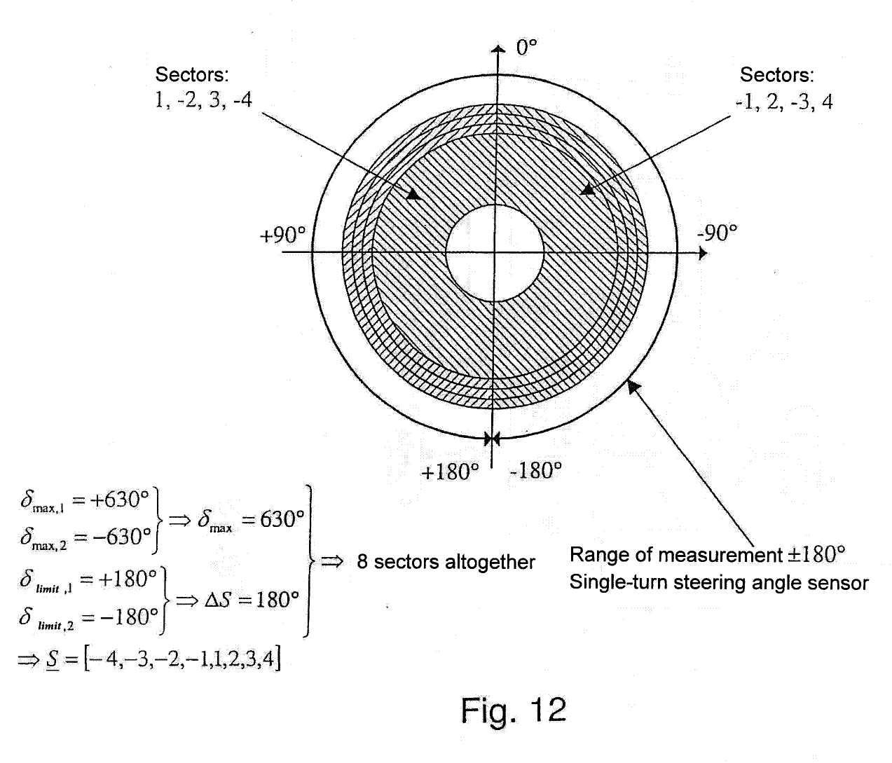

The division into sectors is graphically illustrated for an example in FIG. 12. According to this example, the maximum possible steering wheel angle δ_{max,1} equals +630° in a first steering direction, and the maximum possible steering wheel angle δ_{max,2} equals −630° in a second or opposite steering direction. Furthermore, the maximum angle of rotation δ_{limit,1} that can be detected by the steering angle sensor 61 equals +180° in the first steering direction and the maximum angle of rotation δ_{limit,2} that can be detected by the steering angle sensor 61 in the second steering direction equals −180°. δₘₐₓ=630° and ΔS=180° follow from this. Four sectors are thus obtained per steering direction, i.e., a total of eight sectors.

A preferred prerequisite of this process is the symmetrical division of the possible range of measurement of the single-turn steering angle sensor 61 about the zero position. If the division is not symmetrical, symmetry can be achieved by means of a suitable transformation. A corresponding back transformation is then possible or necessary for the calculation of the absolute steering wheel angle δ_{LRW}.

The step of sector recognition will be described below. The initialization performed so far takes place, e.g., once at the beginning of the calculations. However, the initialization may also be carried out in advance, and the sector size and the number of sectors can be handed over to the process. The particular limits of the sectors are also known with the number and size of the sectors. The sectors are numbered continuously, the numbering of the sectors being between

S=[−n_{S}, . . . , −1, 1, . . . , n_{S}]

and sector “0” is not needed or is not defined. The positive sectors preferably stand for a first steering direction (e.g., turning of the steering wheel to the left), whereas the negative sectors stand especially for a second steering direction (e.g., turning of the steering wheel to the right), which is opposite the first steering direction.

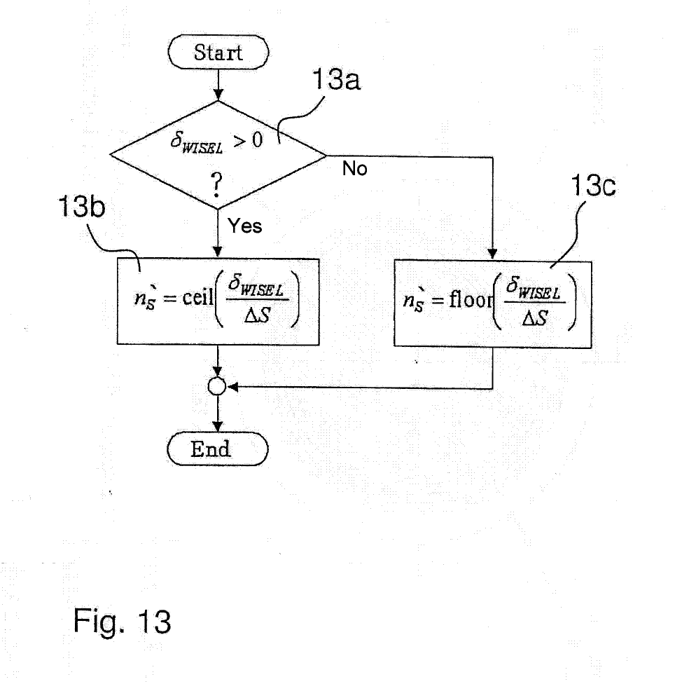

The sector in which the current alternative steering wheel angle δ_{WISEL} is located is determined in the “sector recognition.” A poll (“IF-ELSE” poll) is used for this. The sector recognition procedure can be found in FIG. 13. It is checked in a step 13a whether the alternative steering wheel angle δ_{WISEL} is greater than zero. If yes, the quotient of the alternative steering wheel angle δ_{WISEL} and the sector size ΔS is formed in a step 13b and rounded up to an integer to determine the sector n'_{S}, and the quotient of the alternative steering wheel angle δ_{WISEL} and the sector size ΔS is otherwise formed in a step 13c and rounded off to an integer to determine the sector n'_{S}. The poll can thus be described as follows:

(IF)δ_{WISEL}>0

set

$${n}_{S}^{′} = ceil ( \frac{{δ}_{WISEL}}{Δ S} )$$

### ELSE

set

$${n}_{S}^{′} = floor ( \frac{{δ}_{WISEL}}{Δ S} ) .$$

The result of the roundings is the number n′_{S} of the sector determined. The function “ceil(Argument)” yields now as a result the value of Argument rounded up to an integer.

The alternative steering wheel angle δ_{WISEL} may have a low accuracy and a large noise component. It is possible for this reason to “plausibilize” the sector, which was determined based on the alternative steering wheel angle δ_{WISEL}, by means of the single-turn steering angle sensor 61.

Based on the sector determined in the sector recognition, the range in which the angle measured by the single-turn steering angle sensor must be located in order for the sector determined to be plausible, is checked or determined. The relationship between the measured angle and the sector determined can be found in Table 1 below:

| Sector | Angle range | Sector | Angle range |
|---|---|---|---|
| 1 | 0° . . . + ΔS | −1 | 0° . . . − ΔS |
| 2 | −ΔS . . . 0° | −2 | +ΔS . . . 0° |
| 3 | 0° . . . + ΔS | −3 | 0° . . . −ΔS |
| 4 | −ΔS . . . 0° | −4 | +ΔS . . . 0° |

It is easy to recognize based on Table 1 that there is a relationship between even and odd sector numbers and the respective angle ranges assigned. While one limit is always located at 0°, the other limit is calculated taking into account the sign n_{V} of the sector

$${n}_{v} = \frac{a b s ( S )}{S}$$

and the distinction whether the sector has an even or odd number as follows:

$${δ}_{limit} = \{ \begin{matrix}{n}_{v} \cdot Δ S , for an odd S \\ - {n}_{v} \cdot Δ S , for an even S\end{matrix} .$$

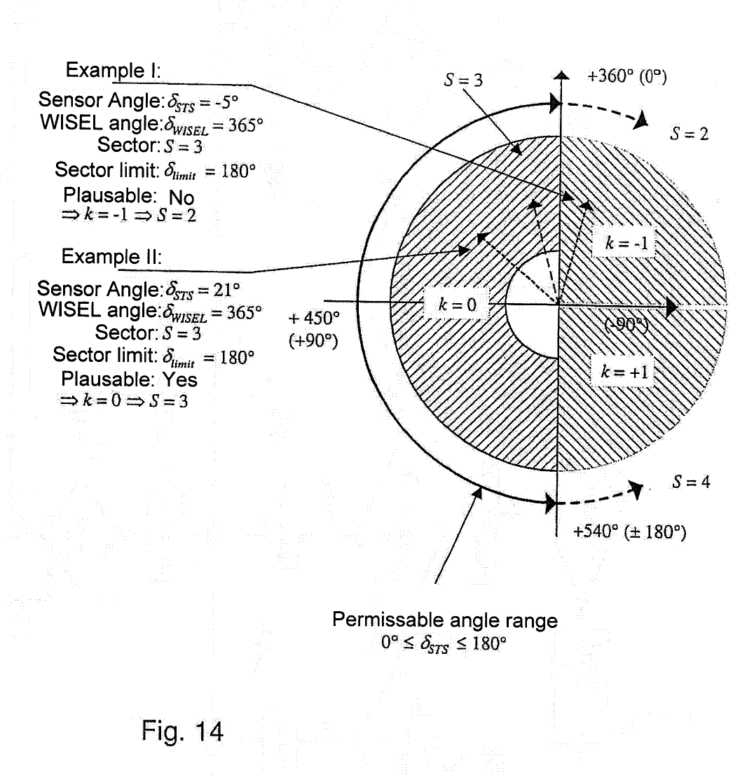

The designation S stands here for the sector number. If the angle of the single-turn steering angle sensor 61 is outside the required angle range, a check is performed to determine the direction in which the sector determined in the sector recognition is to be corrected. The procedure as well as the limits to be newly introduced for this correction can be found in the examples according to FIG. 14. If the angle is closer to a first limit (e.g., 0° in case of sector 1) of the angle range, the sector is corrected towards this limit. If the distance from the other limit (e.g., +ΔS in case of sector 1) is smaller, the sector is corrected towards this limit. The remaining angle range is divided for this decision into two additional ranges, whose size corresponds to half each of the sector size.

According to Example I from FIG. 14, an alternative steering wheel angle δ_{WISEL} of 365° is detected, so that sector S=3 is determined. However, the angle of rotation δ_{STS} is −5° and cannot be located in sector 3 determined (not plausible), whose limit, which is different from 0°, is located at +180°. A correction is therefore performed towards sector 2, which is determined as a new sector. According to Example II from FIG. 14, an alternative steering wheel angle δ_{WISEL} of 365° is detected, so that sector S=3 is determined. The angle of rotation δ_{STS} is at 21° and can consequently be located in sector 3 determined (plausible). It is therefore not necessary to change the sector determined.

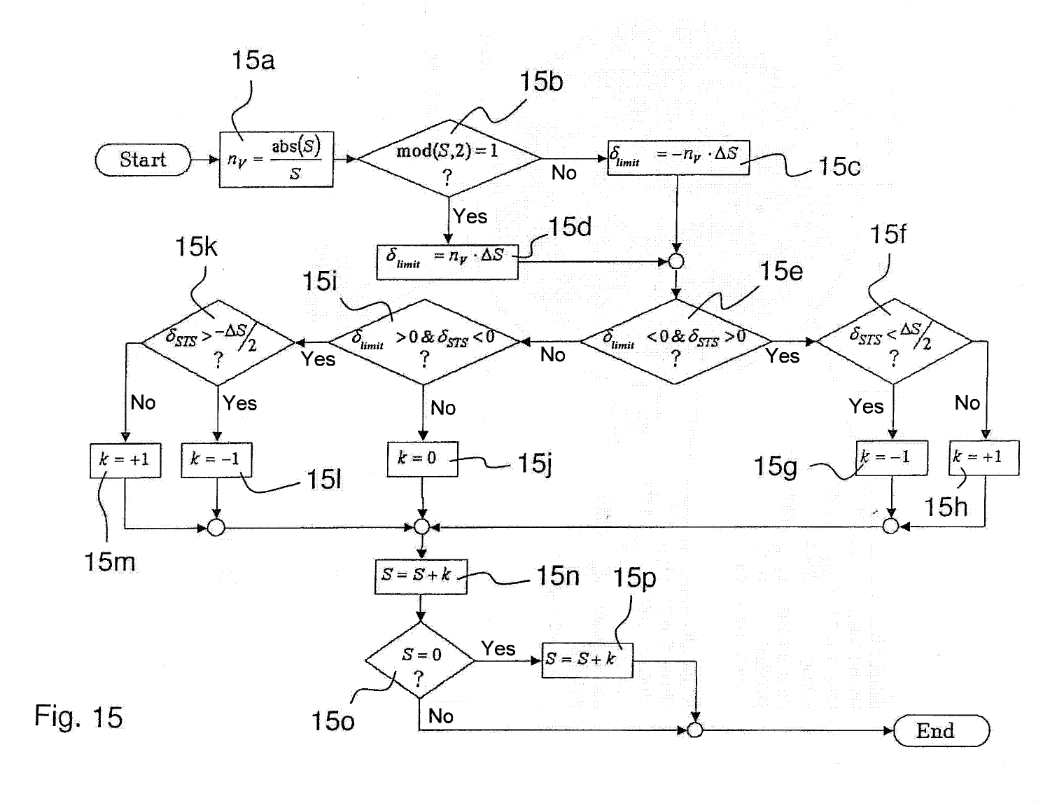

The plausibilization procedure can be found in the flow chart shown in FIG. 15. The sign n_{V} of the sector or of the sector number S is determined at first in a step 15a. A checking is then performed in step 15b to determine whether the sector number is an even or odd number, for which the “mod” function is used. The function mod(Argument 1, Argument 2) now yields as a result the rest of an integer division of Argument 1 by Argument 2. If the sector is an even sector, the sector limit δₗᵢₘᵢₜ, which is different from zero, is calculated in step 15c. If the sector is odd, the sector limit δₗᵢₘᵢₜ, which is different from zero, is calculated in step 15d.

A checking is performed in step 15e to determine whether the sector limit δₗᵢₘᵢₜ is smaller than zero and the angle of rotation δ_{STS} of the steering angle sensor is greater than zero. If yes, a checking is performed in a step 15f to determine whether the angle of rotation δ_{STS} is smaller than half the sector size ΔS/2. If yes, the sector number S is reduced by one in steps 15g and 15n, and the sector number S is otherwise increased by one in steps 15h and 15n. If the checking is negative in step 15e, a checking is performed in step 15i to determine whether the sector limit δₗᵢₘᵢₜ is greater than zero and the angle of rotation δ_{STS} of the steering angle sensor is smaller than zero. If not, the sector number S remains unchanged in steps 15j and 15n, and a checking is otherwise performed in step 15k to determine whether the angle of rotation δ_{STS} is greater than the negative value of half the sector size −ΔS/2. If yes, the sector number S is reduced by one in steps 15l and 15n, and the sector number S is otherwise increased by one in steps 15m and 15n. A checking is performed in step 15o following step 15n to determine whether the sector number S is equal to zero. If not, the sector number remains unchanged, and the previous change in the sector number S, which was already performed in step 15n combined with one of the steps 15g, 15h, 15j, 15l or 15m, is otherwise repeated in step 15p. This means, in particular, that the sector number S is reduced by one in step 15p if S was already reduced by one in steps 15g and 15n or in steps 15l and 15n, or that the sector number S is increased by one in step 15p if S was already increased by one in steps 15h and 15n or in steps 15m and 15n.

The sector number S is now determined on the basis of the alternative steering wheel angle δ_{WISEL} and possibly changed during the plausibilization, taking into account the angle of rotation δ_{STS} sent by the steering angle sensor, so that one can proceed with the determination of the correction factor k.

The angle determined by the single-turn steering angle sensor 61 is to be corrected by the k-th multiple of its maximum possible angle range. Factor k is obtained here from how often the angle range was exceeded. This information is contained, in turn, in the number of the sector. A review for the assignment of a sector and k is shown in Table 2 below:

| Sector | k | Sector | k |
|---|---|---|---|
| +1 | 0 | −1 | 0 |
| +2 | 1 | −2 | −1 |
| +3 | 1 | −3 | −1 |
| +4 | 2 | −4 | −2 |
| +5 | 2 | −5 | −2 |

The calculation rule

$$k = \{ \begin{matrix}floor ( \frac{S}{2} ) , for S > 0 \\ ceil ( \frac{S}{2} ) , for S < 0\end{matrix}$$

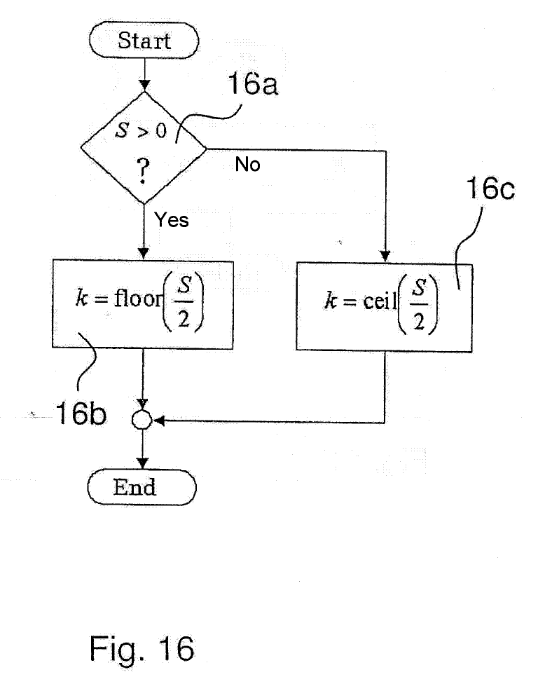

for the correction factor k is derived from Table 2 (sector 0 is not defined). The procedure for determining the correction factor is illustrated in FIG. 16 on the basis of a flow chart. A checking is performed in step 16a to determine whether the sector number S is greater than zero. If yes, the correction factor k is determined in a step 16b for the quotient of the sector number S and number 2, which quotient was already rounded off to an integer, and the correction factor k is otherwise determined in step 16c for the quotient of the sector number S and number 2, which quotient was rounded up to an integer.

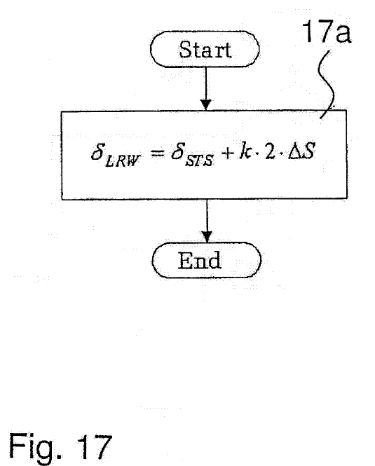

The absolute steering wheel angle δ_{LRW} is now determined, which is obtained from the angle δ_{STS} measured by the single-turn steering angle sensor and the addition of the k-th multiple of the maximum angle range. The calculation can be found in step 17a of the flow chart in FIG. 17, where

δ_{LRW}=δ_{STS}+k·2·ΔS.

An alternative process for sector recognition according to a second embodiment of the present invention will be described below. The process described below is comparable to, but simpler than the process described above. The initialization takes place as described above. However, the determination of the absolute steering wheel angle δ_{LRW}, which is designated by δₖ here, is performed subsequently to the initialization. The following procedure is followed here. Based on the number of sectors n_{S} (per steering direction), a start value is calculated in step 18a for the correction factor k according to

k=−floor(n_{S}/2)−1.

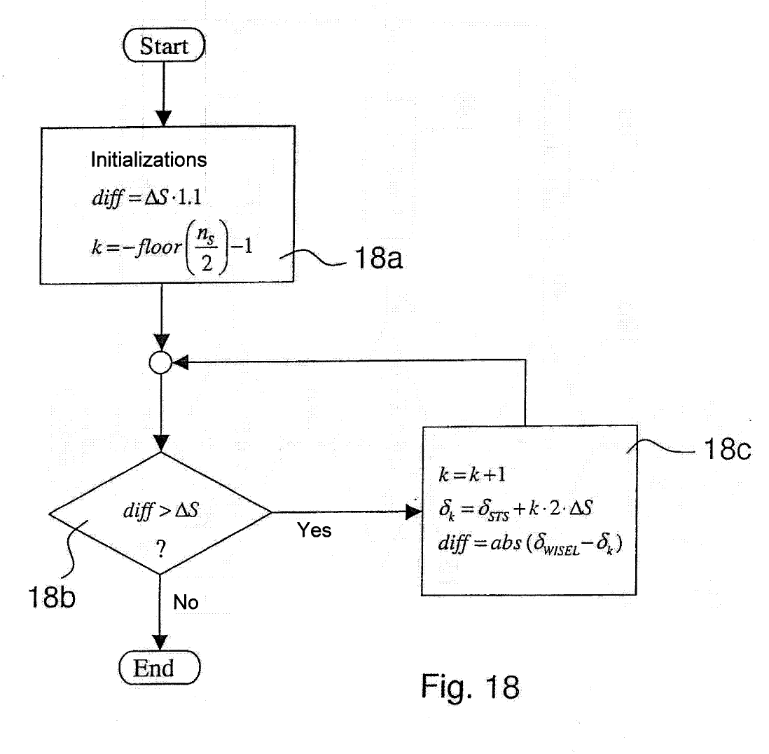

Using this correction factor k, the absolute steering wheel angle δₖ is determined in a step 18c as before (δₖ=δ_{STS}+k·2·ΔS). A checking is then performed in a step 18b to determine whether the value diff from the difference between the alternative steering wheel angle δ_{WISEL} detected by the angle measuring device and the calculated steering wheel angle δₖ is smaller than the sector size ΔS. If yes, the correction factor k determined previously is the proper correction factor k for sector S, and the calculation of the absolute steering wheel angle δₖ is concluded. If the value diff of the difference is greater, the correction factor k is set to a value higher by a numerator (i.e., the number 1 is added to the correction factor k) in step 18c, and the absolute steering wheel angle δₖ is recalculated. This operation is repeated until the value diff of the difference is smaller than the sector size ΔS. The process of calculating the absolute steering wheel angle can be found in FIG. 18.

As is apparent from FIG. 18, the value diff from a product of ΔS and the number 1,1 is formed in step 18a after the initialization. This product is formed only to obtain a starting value for cliff; so that the poll diff>ΔS in step 18b is answered with a “yes” at least during the first run, so that step 18c will be run at least once. Number 1 is added to the correction factor k, the absolute steering wheel angle δₖ is calculated anew as δₖ=δ_{STS}+k·2·ΔS and the value diff is redetermined as diff=abs(δ_{WISEL}−δₖ) in step 18c.

Following the calculation of the absolute steering wheel angle δₖ, the sector in which the steering wheel 58 is located can be determined as well. The procedure herefor is based on the relationship shown in Table 2 between the correction factor k and sector S. The basis for the sector determination is the simple relationship

S=2·k.

If the single-turn steering angle sensor 61 has a positive value δ_{STS} and the sector S resulting from the above equation is likewise positive, sector S must be corrected corresponding to

S=S+1

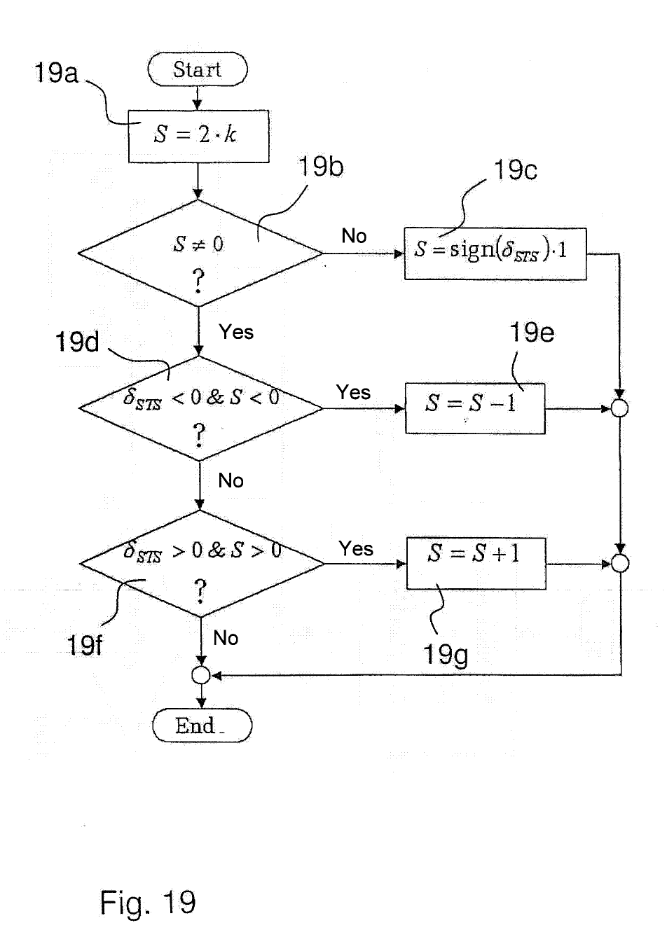

(i.e., one is added to the sector number S). If the value δ_{STS} of the single-turn steering angle sensor 61 is negative and a negative value is obtained for sector S, sector S is corrected downwardly by a numerator (i.e., one is subtracted from the sector number S). The procedure for determining the sector is shown in FIG. 19 on the basis of a flow chart.

A sector S is determined as S=2·k in a step 19a. A checking is performed in step 19b to determine whether the sector in not equal to zero. If not, the sector is calculated as S=sign(δ_{STS}) in a step 19c, where the abbreviation “sign” designates the signum function (also called sign function). Strictly speaking the signum function likewise yields a zero as a function value for the argument zero. However, since a zero sector shall preferably be avoided, it is also possible to use a modified signum function, which yields either +1 or −1 as the function value for the argument zero. If sector S is not equal to zero in step 19b, a checking is performed in a step 19d to determine whether the angle of rotation δ_{STS} is lower than zero and sector S is lower than zero. If yes, the sector number S is reduced by one in a step 19e, and a checking is otherwise performed in a step 19f to determine whether the angle of rotation δ_{STS} is greater than zero and sector S is greater than zero. If yes, the sector number S is increased by one in a step 19g.

Contrary to the procedure described above, the sector is determined according to the alternative process in the knowledge of the correction factor k and not the other way around.

A second alternative process for sector recognition according to a third embodiment of the present invention will be described below. As was already explained in connection with the determination of the alternative steering wheel angle, sector S of the steering wheel 58 can also be determined by means of neuronal networks. The two angles (“WISEL angle horizontal” and “WISEL angle vertical”) of the angle measuring device may be the input variables according to FIG. 9 in this case as well. However, the output variable is now the sector S rather than the steering wheel angle.

While specific embodiments of the invention have been shown and described in detail to illustrate the application of the principles of the invention, it will be understood that the invention may be embodied otherwise without departing from such principles.

1. A process for determining a steering wheel angle of a steering wheel, which is mounted rotatably on a vehicle body and by means of which a wheel is pivotable or pivoted relative to the vehicle body, which wheel is connected to the vehicle body via the intermediary of a joint, which has an angle measuring device, which detects a deflection of said joint, which said deviation depends on the steering wheel angle, wherein an angle of rotation of the steering wheel relative to the vehicle body is determined by means of a steering angle sensor, the process comprising the steps of:
assigning a plurality of sectors per steering direction to a range of the steering wheel angles that can be assumed by the steering wheel; and
determining the steering wheel angle on the basis of the angle of rotation and the sector determined.

2. A process in accordance with claim 1, wherein the size of each sector is smaller than or equal to half the angle range that can be detected by the steering angle sensor.

3. A process in accordance with claim 1, wherein all sectors have the same size.

4. A process in accordance with claim 1, wherein the number of sectors per steering direction is greater by one than the quotient of a maximum angle and the sector size, which is rounded off to an integer and corresponds to the value of the steering wheel angle having the highest possible value.

5. A process in accordance with claim 1, wherein the same number of sectors is assigned to each steering direction.

6. A process in accordance with claim 1, wherein an alternative steering wheel angle is determined on the basis of the deflection and the sector in which the alternative steering wheel angle is located is determined.

7. A process in accordance with claim 1, further comprising the step of checking whether the angle of rotation can be located in the sector determined and if the angle of rotation cannot be located in the sector determined, another sector is determined, in which the angle of rotation is located.

8. A process in accordance with claim 7, wherein the other sector is determined depending on a sector limit to which the angle of rotation is closest.

9. A process in accordance with claim 1, wherein a correction factor, which indicates how often the steering wheel has passed completely through the angle range detectable by the steering angle sensor, is determined on the basis of the sector determined.

10. A process in accordance with claim 9, wherein the steering wheel angle is calculated on the basis of the angle of rotation, the correction factor and the sector size.

11. A process in accordance with claim 1, wherein the deflection is detected as an angle in at least two different directions in space.

12. A process in accordance with claim 11, wherein the directions in space are aligned at right angles to one another.

13. A device for determining a steering wheel angle, the device comprising:
a steering wheel, which is mounted rotatably on a vehicle body and by means of which a wheel can be pivoted in relation to the vehicle body;
a joint with an angle measuring device, said wheel being connected to the vehicle body via the intermediary of the joint the angle measuring device, for detecting a deflection of the joint, which deflection depends on the steering wheel angle;
a steering angle sensor for detecting an angle of rotation of the steering wheel relative to the vehicle body; and
an analysis means for determining the steering wheel angle on the basis of the angle of rotation and the deflection including assigning a plurality of sectors per steering direction to a range of the steering wheel angles that can be assumed by the steering wheel and determining the steering wheel angle on the basis of the angle of rotation and the sector determined, wherein the deflection of the joint can be detected by the angle measuring device as an angle in at least two different directions in space.

14. A device in accordance with claim 13, wherein the wheel is pivotable about a steering axis relative to the vehicle body, the angle measuring device has at least one magnetic field-sensitive sensor and a magnet, whose magnetization is directed obliquely to the steering axis.

15. (canceled)

16. A process for determining a steering wheel angle of a steering wheel mounted rotatably on a vehicle body and by means of which a wheel is pivotable or pivoted relative to the vehicle body, said wheel being connected to the vehicle body via the intermediary of a joint, the process comprising the steps of:
providing the joint with an angle measuring device for detecting a deflection of the joint, which deflection depends on the steering wheel angle;
providing a steering angle sensor for detecting an angle of rotation of the steering wheel relative to the vehicle body;
providing an analysis means for determining the steering wheel angle on the basis of the angle of rotation and the deflection;
assigning a plurality of sectors per steering direction to a range of the steering wheel angles that can be assumed by the steering wheel; and
determining the steering wheel angle on the basis of the angle of rotation and the sector determined.
